(19) United States
(12) Patent Application Publication
(10) Pub. No.: US 2004/0003990 A1
(43) Pub. Date: Jan. 8, 2004

(54) Water purification apparatus and method for purifying water

(76) Inventor: Pierre Mansur, Miami, FL (US)

Correspondence Address: LERNER AND GREENBERG, P.A., POST OFFICE BOX 2480, HOLLYWOOD, FL, 33022-2480, US

(21) Appl. No.: 10/612,588

(22) Filed: Jul. 2, 2003

Related U.S. Application Data
(60) Provisional application No. 60/393,392, filed on Jul. 2, 2002.

(51) Int. Cl. C02F 1/04

(52) U.S. Cl. 202/176; 203/11; 203/1

(57) ABSTRACT

A purifier is connected to tap water and produces pure distilled water. Valves and sensors automatically control functions throughout separate cycles of operation, including distillation, wash, and rejuvenation cycles. During distillation, tap water is boiled in a distillation chamber. A carbon filter captures impurities from the resulting vapors occurring at lower boiling temperatures while higher temperature water vapors are passed through a condenser to produce pure distilled water held in a reservoir. In the wash cycle, a cleaning agent is injected into the distillation chamber, mixed with tap water, and heated and drained prior to rinsing the chamber to remove mineral deposits. During rejuvenation, a heating element superheats pure water remaining in the filter to release contaminants from the filter pores to cleanse and revive the filter media. A flavor agent, minerals, and/or vitamins may be added to the pure water prior to dispensing from a spigot or other fixture.

### CROSS-REFERENCE TO RELATED APPLICATION

This application claims the benefit under 35 U.S.C. § 119(e) of copending U.S. Provisional Application No. 60/393,392, filed Jul. 2, 2002.

### BACKGROUND OF THE INVENTION

1. Field of the Invention

The present invention is directed to water purifying devices and, more particularly, to a compact water distillation unit that connects to a municipal or well water supply for creating pure drinking water, and wherein the unit includes measures for automatic self-maintenance to remove mineral deposit buildup and to revive an activated carbon filter.

2. Discussion of the Related Art

The process of water distillation is well known and is regarded as the most effective way to separate toxins, bacteria, chemicals, and solids from tap water to produce pure drinking water. In the past, various water distillation units have been developed to purify tap water in both commercial and household uses. The primary function of these water distillation units is to heat water and condense the resultant vapors in order to separate and remove contaminants from the municipal water supply prior to use, particularly, in drinking water systems. The distillation process involves heating the water to produce steam, followed by a cooling or condensing of the steam to yield pure water and a by-product that contains all of the contaminants that were separated and removed from the water during the heating and boiling process. This separation of contaminants takes place as a result of various chemicals and other contaminants boiling at different temperatures than pure water. Some contaminants are carried over in the vapor at lower temperatures, while all solids remain in the distillation chamber as the liquid vaporizes. To effectively and efficiently purify water by distillation, it is important to have a controlled way for venting or capturing unwanted vapors that occur at lower temperatures than the boiling point of pure water. This can be achieved with the use of an activated carbon filter that captures the contaminants and solids that separate from the tap water at lower temperatures during the distillation process. It is also beneficial to have measures for automatically deactivating the heating elements once the tap water has been completely boiled and converted to the vapor state.

The water distillation units presently known in the art have several shortcomings that limit their usefulness as a practical and desirable measure for providing pure water, particularly, in a household environment. For instance, water distillation units currently available on the market are usually bulky and are often designed to require inconvenient and unsightly positioning on countertops. Most of these units require manual filling and/or manual removal of the distilled water prior to use. Periodically, the distillation unit must be manually cleaned to remove calcium deposits and other mineral deposits that build up on the interior surfaces, particularly, in the distillation chamber. These deposits adversely affect the function of many of the components, including the heating element, and limit the overall cleanliness of the unit. The labor intensive method to remove these contaminants requires manual disassembly of the unit and separation of parts, which are, then, soaked in certain chemicals, such as citric acid. The chemicals react with the deposits, eventually causing them to dissolve and separate from the surfaces of the soaked parts.

The production of truly pure distilled water can be problematic, and many existing water distillers are not entirely effective in removing all contaminants. Higher quality water distillation units provide for removal or “scrubbing” of contaminants from vapors created in the distillation chamber. Post filtration (i.e., using activated media) is the accepted method to assure final scrubbing of the distilled water to remove any unwanted vapors that pass through the system from the distillation chamber. Although venting the initial vapors before they recondense is effective, high-quality final scrubbing, using post filtration, produces the purest water. At present, activated carbon is the preferred media to remove organics and other contaminants due to its natural ability to attract and retain the unwanted and unhealthy chemicals. However, activated carbon filter media becomes saturated in time and must be monitored, maintained, and manually replaced on a regular basis.

A further drawback associated with presently known water distillation units is poor energy efficiency which results due to the significant amount of energy required to heat and vaporize water in the distillation process. Furthermore, water in its purest state typically has a neutral or bland taste because it lacks the flavor of the minerals found in water that most people are accustomed to drinking. These flavor-producing minerals are removed by distillation, leaving the pure water with a taste that does not appeal to most consumers.

### SUMMARY OF THE INVENTION

It is accordingly an object of the invention to provide a water purification apparatus that overcomes the hereinafore-mentioned disadvantages of the heretofore-known devices and methods of this general type and that can be used in a household environment, is not bulky, is easy to use, self cleans, and is energy efficient.

The present invention is directed to a water purification apparatus which includes a configuration of components contained in a compact unit for mounting in either an internal location (e.g., under a countertop) or an external location (e.g., wall mounted or countertop mounted). The water purification apparatus connects to a municipal or well water (i.e., tap water) supply and is structured and disposed to automatically and economically create pure distilled water for dispensing on demand. The apparatus is structured to automatically maintain a set schedule to wash a distillation chamber and revive activated carbon of a post filter. Specifically, the apparatus includes precisely timed valves and sensors that automatically control a sequence of functions throughout separate cycles of operation, including a distillation cycle, a wash cycle, and a rejuvenation cycle.

During the distillation cycle, tap water is directed into a distillation chamber where it is heated to a boiling temperature by a heating element to produce vapors. An activated carbon post filter captures impurities from vapors that occur at lower boiling temperatures. The pure water vapors, which occur at a set temperature, are passed through a condenser where they are condensed to produce pure distilled water. The pure distilled water is, then, directed into a containment reservoir that holds a predetermined volume of pure distilled water. When the containment reservoir is filled to a predetermined level, a float switch is actuated to interrupt subsequent distillation cycles until a sufficient amount of pure water is dispensed from the apparatus to lower the level in the containment reservoir. A pump delivers the pure distilled water, under pressure, from the containment reservoir to a dispensing spigot or other fixture. A normally closed valve at the dispensing spigot is operated by the user to selectively release pure distilled water from the spigot on demand. The apparatus may, further, be provided with measures for chilling or heating the pure distilled water prior to dispensing. Moreover, any of a variety of flavor agents and/or health benefiting minerals and vitamins may be added to the pure distilled water prior to dispensing from the spigot.

Upon activation of the wash cycle, a metered amount of cleaning agent is injected into the distillation chamber and is mixed with tap water. The mixture is, then, heated and drained from the distillation chamber. Thereafter, the distillation chamber is rinsed with tap water to complete the washing and removal of mineral deposits and other contaminants that build up in the distillation chamber during the distillation process.

During the rejuvenation cycle, a post-filter heating element is activated for superheating the pure water that remains in the activated carbon media of the post-filter. This causes contaminants to be shocked and released from the filter pores, thereby reviving the activated carbon in the post-filter.

The present invention provides a compact, self-contained, and self-monitoring water distillation apparatus that automatically and economically creates pure distilled water, and that, further, maintains a set schedule to automatically wash the distillation chamber and automatically revive activated carbon in a post-filter chamber.

The present invention also provides a water distillation apparatus that includes separate cycles of operation, including a distillation cycle, a wash cycle, and a post-filter rejuvenation cycle.

The present invention further provides a water distillation apparatus that includes precisely timed valves and sensors for controlling a sequence of functions throughout the separate cycles of operation.

The present invention, moreover, provides a completely integrated, stand-alone, and maintenance free water distillation unit.

The present invention provides a water distillation unit in a compact housing that is configured to allow for mounting of the unit in both internal locations (e.g., under a countertop) and external locations (e.g., wall mounted, countertop mounted).

The present invention also provides a water distillation apparatus that dispenses both chilled and heated distilled pure water.

The apparatus according to the present invention can add any of a variety of flavors and/or health benefiting minerals and vitamins to the distilled pure water prior to dispensing.

Finally, the present invention provides a compact, self-contained and self-monitoring water distillation apparatus that is energy efficient and that requires minimal maintenance, and, further, wherein the apparatus includes the use of ceramic self-cleaning valves.

Other features that are considered as characteristic for the invention are set forth in the appended claims.

Although the invention is illustrated and described herein as embodied in a water purification apparatus, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a diagrammatic cross-sectional view of a first embodiment of a water purification apparatus according to the invention;

FIG. 2 is diagrammatic cross-sectional view from the side of a timing mechanism used to control the various valves of the apparatus of FIG. 1 throughout a sequence of functions in the various cycles of operation of the apparatus;

FIG. 3 is a diagrammatic cross-sectional view from the rear of the timing mechanism of FIG. 2;

FIG. 4 is a chart indicating the valve positions in the various cycles of operation of the apparatus of FIG. 1;

FIG. 5 is a diagrammatic cross-sectional view of a second embodiment of a water purification apparatus according to the invention;

FIG. 6 is diagrammatic cross-sectional view from the side of the apparatus of FIG. 1;

FIG. 7 is a diagrammatic cross-sectional view of the apparatus of FIG. 6 along section line VII-VII in FIG. 6; and

FIG. 8 is a diagrammatic cross-sectional view from the side of a timing mechanism used to control the various valves of the apparatus of FIG. 5 throughout a sequence of functions in the various cycles of operation of the apparatus.

### DETAILED DESCRIPTION OF THE PREFERRED EMBODIMENTS

In the figures of the drawings, unless stated otherwise, identical reference symbols denote identical parts.

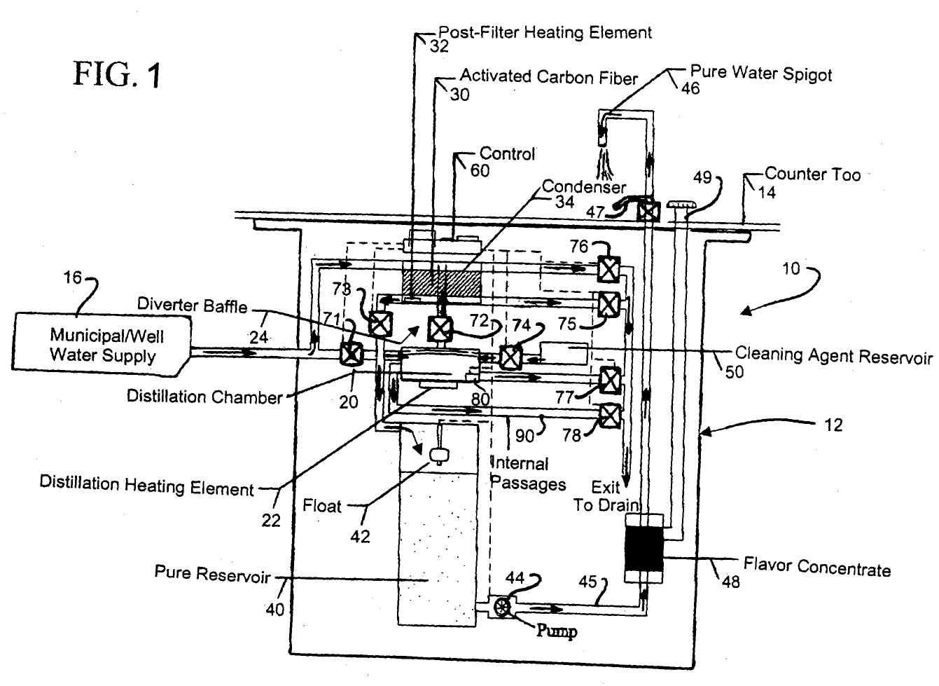

Referring now to the figures of the drawings in detail and first, particularly to FIG. 1 thereof, there is shown a water purification apparatus 10 according to the invention. The apparatus 10 includes an assembly of components that are, preferably, contained within a compact housing 12. The housing 12 may be structured and configured to accommodate various mounting styles and locations. For instance, the housing 12 may be configured as a stand alone unit that rests on a countertop. Alternatively, the housing 12 may be structured for mounting to the exposed side of a countertop, a wall surface, or the underside of a cabinet. In the first exemplary embodiment shown in FIG. 1, the housing 12 is structured and configured for an interior mounting, and, specifically, for under a countertop 14 so that the housing 12 remains concealed from normal view.

The apparatus 10 connects to the main water supply 16 of a house or building, which, in most instances, is either a municipal water supply or a well water supply. Hereinafter, the water from the general water supply 16 will be referred to as tap water. The water purification apparatus 10 is, specifically, structured and disposed to convert the tap water into pure distilled water, as described more filly hereinafter.

Referring to FIG. 1, the principal components of the water purification apparatus 10 are shown in a functional schematic diagram. It is recognized that the specific structure, arrangement, and configuration of the components is not limited to the embodiment shown in FIG. 1. Moreover, it is recognized that the arrangement and configuration of the components shown in FIGS. 1 to 8 are for illustrative purposes only, to facilitate an understanding of the present invention, and, in a reduction to practice, the specific components and configuration thereof may be varied to achieve the principal objective of the present invention, which is to automatically and economically create pure distilled water from tap water while automatically maintaining a set schedule to wash the distillation chamber and revive the activated carbon of the post filter in the apparatus 10, thereby providing a compact, self-contained, and self-monitoring water distillation unit.

In the preferred embodiment, as shown in FIG. 1, the apparatus 10 includes a distillation chamber 20 that communicates with the incoming tap water supply 16. During a distillation cycle, the distillation chamber 20 is filled with tap water to a predetermined level. A heating element 22 heats the tap water in the distillation chamber 20 until the tap water reaches a boiling temperature, thereby causing the tap water to vaporize. To stabilize and equalize the vapor temperature, the rising vapors are directed through a diverter baffle 24 to completely and effectively remove contaminants, especially, bacteria and viruses. The diverter baffle 24 serves the effect of lengthening the vapor path from the distillation chamber to an activated carbon filter 30 and condenser 34, thereby providing a full and even heating of the vapors before exiting the distillation chamber 20. The diverter baffle 24, preferably, has a labyrinth structure therein.

Once leaving the distillation chamber 20, the vapors are directed through the condenser 34 and the vapors are cooled either by air or a liquid to condense the vapors into a liquid state. The liquid, then, passes through the activated carbon filter 30, which contains a bed of activated carbon that captures impurities having a boiling temperature that is lower than pure water. Specifically, the lower temperature vapors and fluids containing impurities through the activated carbon are captured within the filter pores. After passing through the activated carbon filter 30 to remove impurities, the pure distilled water is directed into a distilled water containment reservoir 40, which holds a predetermined volume of pure distilled water for ready dispensing on demand. A float switch 42 monitors the level of pure drinking water in the reservoir 40. When the pure water level drops, the float switch 42 activates the distillation cycle to produce additional quantities of pure distilled water. Once the containment reservoir 40 fills to the predetermined full level, the float switch 42 signals a control device 60 to disable the distillation cycle function. A pump 44 transfers the pure distilled water, under pressure, from the containment reservoir 40 and through exit passage 45 to a dispensing spigot 46 or other dispensing fixture. A lever-controlled valve 47 is, normally, closed to interrupt discharge of the pure water from the spigot. Upon actuation of the lever 47, the pure distilled water is dispensed from the spigot for filling into a drinking glass, container, or other vessel, as needed. The containment reservoir 40 continually refills to provide pure distilled water from the dispensing spigot 46 on demand. As seen in FIG. 1, a flavor concentrate 48 of any of a variety of flavors and/or minerals and/or vitamins, can be added to the pure distilled water prior to dispensing from the spigot 46. A fill port 49, such as that shown above the countertop 14, may be provided for adding flavor concentrate and/or vitamins and minerals, to a container or cartridge within the housing 12.

During a cleaning cycle, a cleaning agent contained in cleaning agent reservoir 50 is dispensed into the distillation chamber 20. More particularly, a predetermined measured charge of cleaning agent is released into the distillation chamber 20 and is mixed with tap water from the general water supply 16. The heating element 22, then, heats the mixture of cleaning agent and water, causing release and/or breakdown of mineral deposits, such as calcium, as well as other contaminants that build up on the interior wall surfaces of the distillation chamber 20. The distillation chamber is, then, rinsed to remove the deposits and cleaning agent mixture in preparation for subsequent distillation cycles. The cleaning cycle can be carried out over any period of time. Preferably, the cleaning cycle is carried out on a monthly basis. Alternatively, the cleaning cycle can be carried out based upon an amount of water that has been distilled. Similarly, the rejuvenation cycle can be carried out over any period of time. Preferably, the rejuvenation cycle is carried out on a monthly basis. Alternatively, the rejuvenation cycle can be carried out based upon an amount of water that has been distilled.

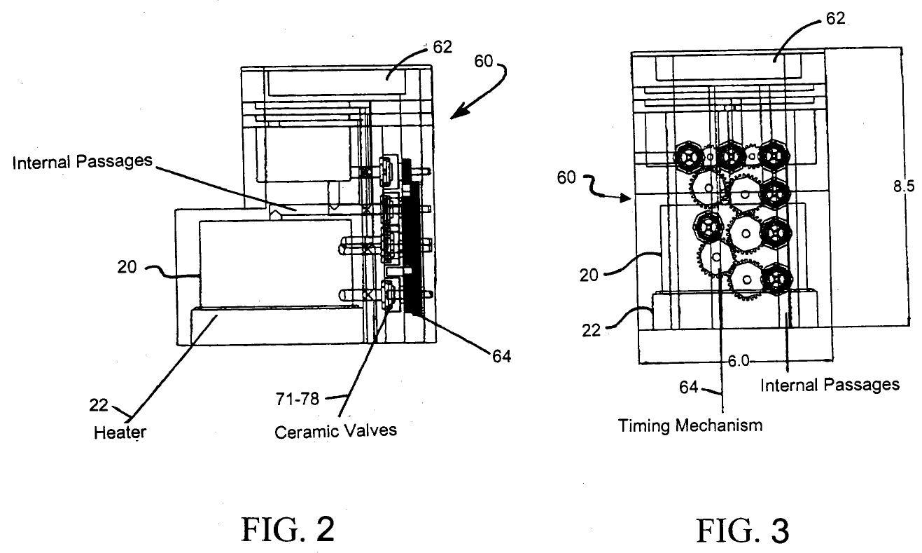

A control device 60 includes a controller 62 that controls, monitors, energizes, and cycles all valves 71 to 78 throughout the distillation, wash, and rejuvenation cycles. Specifically, the controller 62 operates a timing mechanism 64, which can be embodied as a series of gears, as shown in FIGS. 2, 3, 6, and 8, to precisely operate the ceramic valves 71 to 79 according to timed sequences throughout the distillation, wash, and rejuvenation cycles. The controller 62 further communicates with sensors, including the float switch 42, to control initiation, interruption, and bypass of any of the three phases of cycle operation.

The sequence of operation throughout the distillation, wash and rejuvenation cycles with regard to the embodiment of FIG. 1 is described as set forth in the following text.

Distillation Cycle

Whenever the float switch 42 senses the pure water level dropping below a predetermined level in the containment reservoir 40, a signal is delivered to controller 62 to activate the distillation-only cycle. To begin the distillation cycle, valve 71 opens to allow tap water to enter the distillation chamber from the municipal/well water supply 16. Valve 78 opens to govern the level of the incoming tap water so that the tap water fills to a predetermined level in the distillation chamber 20, with excess water being spilled over and released through exit passage 90, through open valve 78, and out to a drain exit. When the distillation chamber 20 is filled with tap water, valve 71 is closed and the heating element 22 is activated. Valve 78 closes after an initial purge of vapors results from the heating of the tap water in the distillation chamber. At this point, valves 72 and 73 open. The opening of valve 72 allows the vapors from the boiled tap water to enter the condenser 34. Opening valve 73 allows the pure distilled water, condensed in the condenser 34, to be directed into the containment reservoir 40. Once all of the tap water is boiled and vaporized in the distillation chamber 70, a sensor 80 signals the controller 62 to indicate that the distillation cycle has been completed. At this point, controller 62 controls operation of the valves to return all valves 71 to 78 to the closed position, and the heating element 22 is deactivated. The distillation cycle may be restarted and repeated until the containment reservoir 40 is filled with pure distilled water to a predetermined full level.

Wash Cycle

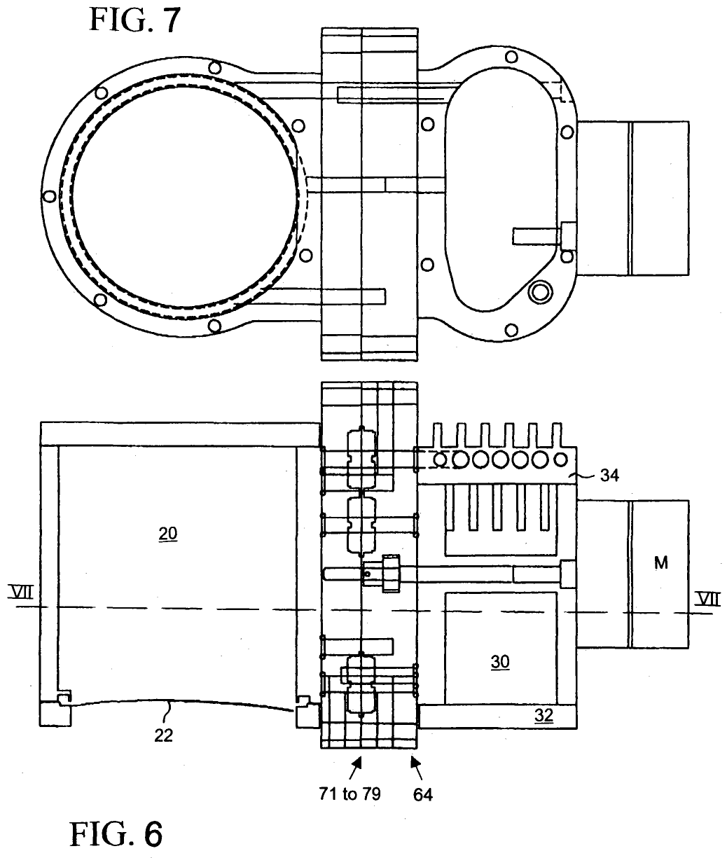

The timing mechanism 64 illustrated in FIGS. 3 and 6 accounts for actuation of a wash cycle according to a predetermined schedule to remove buildup of mineral deposits, such as calcium and other contaminants, within the distillation chamber. When a scheduled wash of the distillation chamber is reached, the wash cycle is initiated by the opening of valve 74 to allow a metered amount of cleaning agent to be injected into the distillation chamber 20. Once the cleaning agent is injected into the distillation chamber, valve 74 closes and the agent mixes with the predetermined amount of tap water remaining in the distillation chamber. The heating element 22 is activated to heat the mixture of cleaning agent and water within the distillation chamber. After heating for a predetermined time, to a predetermined temperature, valve 77 opens to allow the cleaning mixture to drain from the distillation chamber 20. Thereafter, valve 71 opens to release tap water into the distillation chamber for rinsing the remaining cleaning agent and deposits from the distillation chamber and out through open valve 77 to an exit drain. Once the distillation chamber is thoroughly rinsed and cleaned, valve 71 and valve 77 are operated to the closed position. At this point, the wash cycle has been completed.

Rejuvenation Cycle

The timing mechanism 64 further provides for operation of a rejuvenation cycle according to a predetermined schedule. Upon activation of the rejuvenation cycle, post filter heating element 32 is activated to heat and boil a small amount of water that remains within the activated carbon of the post filter chamber throughout the distillation cycle. Shortly after activation of the heating element 32, all valves 71 to 78 are operated to the closed position and the water in the activated carbon is superheated to a temperature above its boiling point. This causes contaminants in the activated carbon to be steamed, shocked, and released. After a predetermined period of time, valve 75 is opened allowing the superheated steam and contaminants to be released from the activated carbon filter and out through the drain exit. Thereafter, valve 75 is closed, thus, completing the rejuvenation cycle.

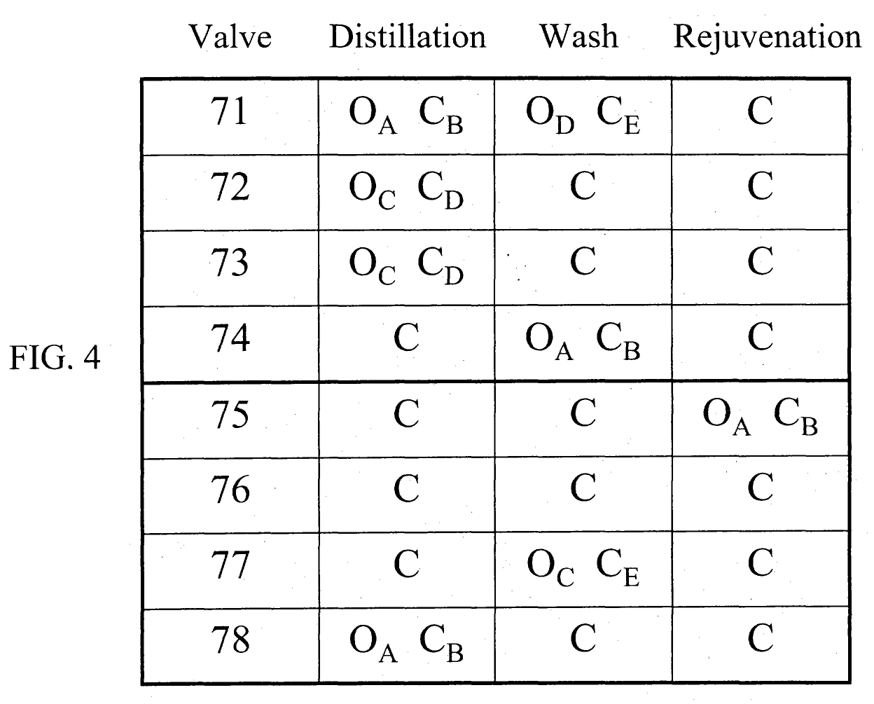

A chart indicating the valve operation process for each of the distillation, wash, and rejuvenation cycles for the embodiment of FIG. 1 is shown in FIG. 4.

Specifically, in the first step A of the distillation cycle, valves 71 and 78 open (not necessarily simultaneously). In the second step B, valve 71 closes and then valve 78 closes. In the third step C, valves 72 and 74 open (not necessarily simultaneously). Finally, in the fourth step D, valves 72 and 74 close (not necessarily simultaneously, but, preferably, simultaneously). Valves 74, 75, 76, and 77 remain closed throughout the distillation cycle.

In the first step A of the wash cycle, valve 74 opens. In the second step B, valve 74 closes. In the third step C, valve 77 opens. In the fourth step D, valve 71 opens. In the fifth step E, valve 71 and 77 close. Valves 72, 73, 75, 76, and 78 remain closed throughout the wash cycle.

In the first step A of the rejuvenation cycle valve 75 opens and valve 75 closes in the second step B. All other valves remain closed throughout the rejuvenation cycle.

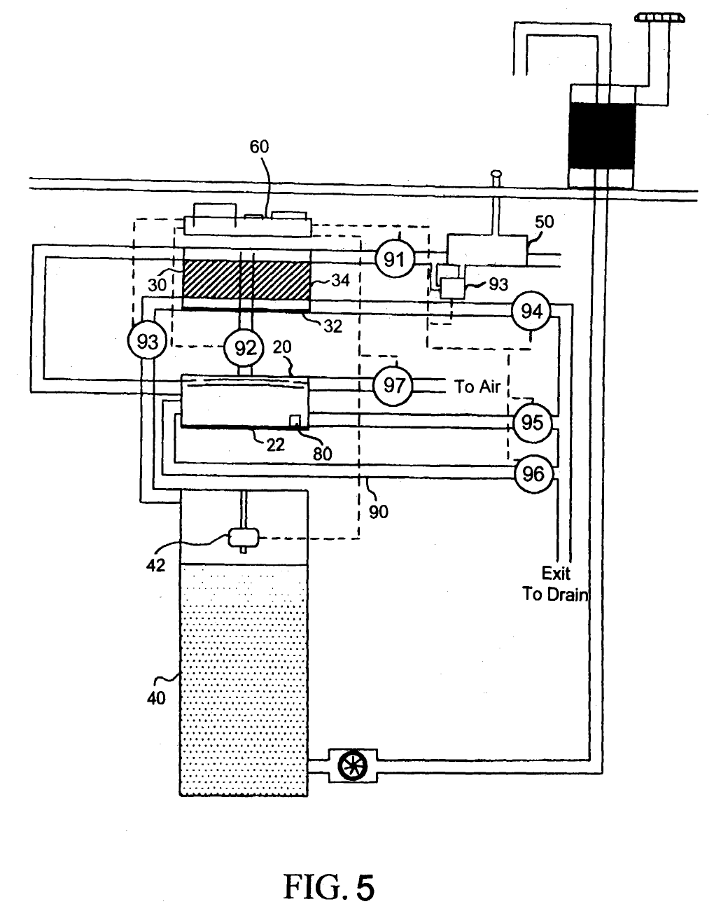

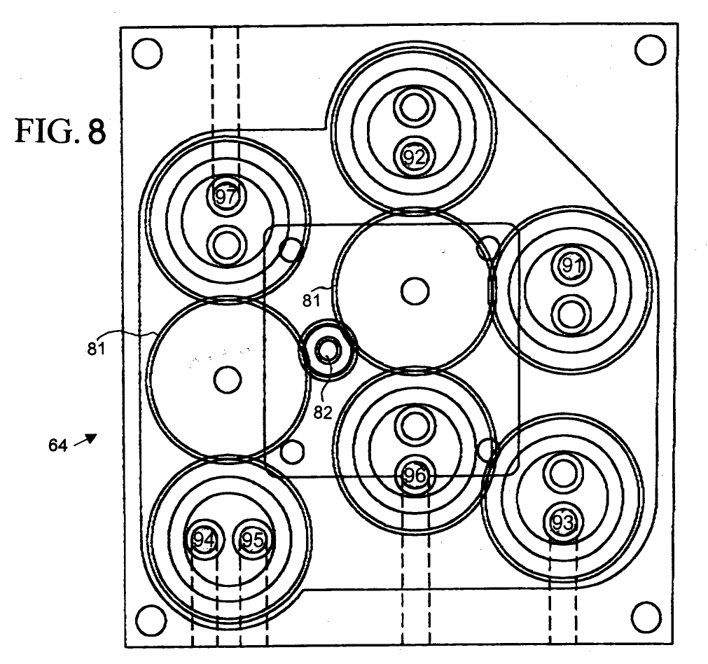

FIG. 5 is an alternative and preferred embodiment of the water purification apparatus according to the present invention. FIG. 6 is a diagrammatic cross-sectional view of a preferred embodiment of the apparatus of FIG. 5 showing the distillation chamber 20, the heating element 22, the carbon filter 30, the post-filter heating element 32, the condenser 34, and a motor M for operating the valves 91 to 97. FIG. 8 is a preferred embodiment of the timing mechanism 64 for operating the valves 91 to 97. The motor M is connected to drive 82, which, in turn, rotates two clutches 81 when the valves 91 to 97 need to be operated. The sequence of operation throughout the distillation, wash and rejuvenation cycles with regard to the embodiment of FIG. 5 is described as set forth in the following text.

Distillation Cycle

Whenever the float switch 42 senses the pure water level dropping below a predetermined level in the containment reservoir 40, a signal is delivered to the control device 60 to activate the distillation-only cycle. To begin the distillation cycle, valve 91 opens to allow tap water to pass over the condenser 34 to cool the condenser 34 while tap water is forced into the distillation chamber 20. Valve 96 opens, the heater 22 is turned on and pressure forces the desired level while the valve 96 remains open to allow unwanted vapors below the water vapor temperature to escape and to govern the level of the incoming tap water so that the tap water fills to a predetermined level in the distillation chamber 20, with excess water being spilled over and released through exit passage 90, through open valve 96 and out to a drain exit. When the distillation chamber 20 is filled with tap water, valve 91 is closed and the heating element 22 is activated. Valve 96 closes after an initial purge of vapors results from the heating of the tap water in the distillation chamber. At this point, valves 92 and 93 are opened to allow vapors to pass into the condenser 34 and the cooled water to pass through the charcoal 30 and into the reservoir 40. The opening of valve 92 allows the vapors from the boiled tap water to enter the condenser 34. Opening valve 93 allows the pure distilled water, condensed in the condenser 34, to be directed into the containment reservoir 40. Once all of the tap water is boiled and vaporized in the distillation chamber 70, a sensor 80 signals the control device 60, indicating that the distillation cycle has been completed. At this point, controller 62 controls operation of the valves to return all valves 91 to 96 to the closed position, and the heating element 22 is deactivated. The distillation cycle may be restarted and repeated until the containment reservoir 40 is filled with pure distilled water to a predetermined full level.

Wash and Rejuvenation Cycle

The timing mechanism 64 accounts for actuation of a wash and rejuvenation cycle according to a predetermined schedule in order to remove buildup of mineral deposits, such as calcium, and other contaminants within the distillation chamber. When a scheduled wash and rejuvenation of the distillation chamber is reached, the post filter heating element 32 is activated to heat and boil a small amount of water that remains within the activated carbon of the post filter chamber throughout the distillation cycle. Shortly after activation of the heating element 32, all valves 91 to 96 are operated to the closed position and the water in the activated carbon is superheated to a temperature above its boiling point. This causes contaminants in the activated carbon to be shocked and released. After a predetermined period of time, valves 94, 95 and 97 are all opened to allow drainage to a drain through valves 94 and 95 and to allow venting for the totally sealed purification unit through valve 97.

While the instant invention has been shown and described in accordance with a preferred and practical embodiment thereof, it is recognized that departures from the instant disclosure are contemplated within the spirit and scope of the present invention.

I claim:

1. A self-cleaning water purification apparatus for automatically creating pure distilled water for dispensing on demand, comprising:
a housing;
an input tube connected to said housing, said input tube to be connected to a household tap water supply for receiving tap water;
a distillation chamber disposed in said housing and communicating with said input tube for heating the tap water to a boiling temperature and producing vapors therefrom;
a condenser disposed in said housing and communicating with said distillation chamber, said condenser condensing the vapors into a condensed liquid;
a post-filter disposed in said housing and communicating with at least one of said distillation chamber and said condenser, said post-filter capturing impurities from the condensed vapors to produce pure distilled water in a distillation cycle, said post-filter having:
a filter material for filtering the condensed liquid; and
a post-filter heating element for superheating the water in said filter material to clean said filter material during a rejuvenation cycle;
a reservoir disposed in said housing and communicating with at least one of said post filter and said condenser for holding a predetermined volume of the pure distilled water; and
a cleaning agent chamber containing a cleaning agent, said cleaning agent chamber communicating with said distillation chamber and supplying a given amount of said cleaning agent to said distillation chamber for cleaning said distillation chamber in a cleaning cycle.

2. The apparatus according to claim 1, further comprising valves and sensors automatically controlling said distillation cycle, said cleaning cycle, and said rejuvenation cycle.

3. The apparatus according to claim 2, further comprising a drain to the environment, said valves including:
a valve disposed between said input tube and said distillation chamber;
a valve disposed between said distillation chamber and said condenser;
a valve disposed between said condenser and said reservoir;
a valve disposed between said distillation chamber and said cleaning agent chamber;
a valve disposed between said post-filter and said drain;
a valve disposed between said condenser and said drain; and
at least one valve disposed between said distillation chamber and said drain.

4. The apparatus according to claim 2, further comprising a drain to the environment, said valves including:
a valve disposed between said input tube and said condenser;
a valve disposed between said distillation chamber and said condenser;
a valve disposed between said post-filter and said reservoir;
a valve disposed between said post-filter and said drain;
at least one valve disposed between said post-filter and said drain; and
a valve disposed between said distillation chamber and the environment.

5. The apparatus according to claim 2, wherein said sensors include a sensor disposed in said distillation chamber detecting when the tap water in said distillation chamber has vaporized.

6. The apparatus according to claim 2, wherein said valves are ceramic valves.

7. The apparatus according to claim 2, further comprising a float switch disposed in said reservoir, said float switch detecting a level of the pure distilled water in said reservoir and controlling flow of the tap water into said distillation chamber dependent upon said level.

8. The apparatus according to claim 7, wherein said float switch interrupts subsequent distillation cycles until an amount of pure water is dispensed from said reservoir and lowers said level in said reservoir.

9. The apparatus according to claim 8, further comprising a control device connected to said valves, said sensors, and said float switch for controlling and monitoring said valves during said distillation cycle, said cleaning cycle, and said rejuvenation cycle.

10. The apparatus according to claim 1, further comprising a diverter baffle fluidically connecting said distillation chamber and said condenser.

11. The apparatus according to claim 1, further comprising:
a water dispenser; and
a pump communicating with said dispenser and said reservoir, said pump delivering the pure distilled water under pressure from said reservoir to said dispenser.

12. The apparatus according to claim 11, further comprising a flavor agent chamber containing a flavor agent, said flavor agent chamber disposed between said reservoir and said dispenser for flavoring the pure distilled water dispensed to a user.

13. The apparatus according to claim 1, further comprising a flavor agent chamber containing a flavor agent, said flavor agent chamber communicating with said reservoir for flavoring the pure distilled water dispensed to a user.

14. The apparatus according to claim 1, wherein said flavor agent chamber has a fill port for filling said flavor agent chamber with said flavor agent.

15. The apparatus according to claim 1, wherein said housing is shaped to be mounted at least one of under a countertop, under a cabinet, at a wall, and on a countertop.

16. The apparatus according to claim 1, wherein said condenser fluidically connects said input tube to said distillation chamber.

17. The apparatus according to claim 1, wherein said filter material is activated carbon.

18. The apparatus according to claim 1, wherein said post-filter captures impurities from the condensed vapors occurring at boiling temperatures lower than the boiling temperature of water.

19. A method for automatically creating pure distilled water for dispensing on demand and performing self-cleaning, which comprises:
automatically carrying out a distillation cycle by:
filling a distillation chamber with tap water to a predetermined level;
heating the tap water in the distillation chamber until the tap water reaches a boiling temperature and, thereby, causes the tap water to vaporize;
directing rising vapors through a condenser to cool and condense the vapors into a liquid state, and directing the liquid through a filter to remove and capture impurities therefrom and produce pure distilled water;
directing the pure distilled water from the filter into a reservoir holding a predetermined volume of the pure distilled water for ready dispensing on demand;
automatically monitoring a level of the pure drinking water in the reservoir; and
continuously re-activating the distillation cycle when the level drops below a given level to produce additional quantities of the pure distilled water and to automatically maintain the level at the given level and ceasing the distillation cycle when the level rises to the given level;
periodically carrying out a cleaning cycle to at least one of release and break down deposits and contaminants in the distillation chamber; and
periodically carrying out a filter rejuvenation cycle to release contaminants from the filter.

20. The method according to claim 19, which further comprises performing the periodic cleaning cycle by:
dispensing a given amount of cleaning agent from a cleaning agent reservoir into the distillation chamber and mixing the cleaning agent with at least some tap water in the distillation chamber;
heating the mixed tap water and cleaning agent with a water heating element to at least one of release and break down deposits and contaminants in the distillation chamber; and
rinsing the distillation chamber to remove the deposits and the mixed tap water and cleaning agent from the distillation chamber.

21. The method according to claim 19, which further comprises performing the periodic filter rejuvenation cycle by:
sealing off the filter;
activating a filter heating element to superheat water remaining in the filter and, thereby, release contaminants from the filter; and
unsealing the filter to remove the released contaminants therefrom.

22. The method according to claim 19, which further comprises performing the periodic cleaning and rejuvenation cycles by:
dispensing a given amount of cleaning agent from a cleaning agent reservoir into the distillation chamber and mixing the cleaning agent with at least some tap water in the distillation chamber;
heating the mixed tap water and cleaning agent with a water heating element to at least one of release and break down deposits and contaminants in the distillation chamber;
rinsing the distillation chamber to remove the deposits and the mixed tap water and cleaning agent from the distillation chamber;
sealing off the filter;
activating a filter heating element to superheat water remaining in the filter and, thereby, release contaminants from the filter; and
unsealing the filter to remove the released contaminants therefrom.

23. The method according to claim 19, which further comprises controlling a sequence of the distillation, wash, and rejuvenation cycles timed valves and sensors.

24. The method according to claim 19, which further comprises directing rising vapors through a diverter baffle to remove contaminants in the tap water.

25. The method according to claim 19, which further comprises:
carrying out the automatic monitoring by automatically monitoring a level of the pure drinking water in the reservoir with a float switch; and
re-activating the distillation cycle with the float switch.

26. The method according to claim 19, which further comprises delivering the pure distilled water under pressure from the containment reservoir to a dispenser.

27. The method according to claim 19, which further comprises automatically controlling a sequence separate cycles of the distillation cycle, the wash cycle, and the rejuvenation cycle with valves and sensors.

28. The method according to claim 19, which further comprises cooling the condenser by filling the distillation chamber with the tap water.

29. The method according to claim 19, which further comprises adding a flavor agent to the pure distilled water prior to dispensing to a user.

30. A method for automatically creating pure distilled water for dispensing on demand and performing self-cleaning, which comprises:
providing an apparatus according to claim 1; and
automatically carrying out the distillation cycle by:
filling the distillation chamber with tap water to a predetermined level;
heating the tap water in the distillation chamber until the tap water reaches a boiling temperature and, thereby, causes the tap water to vaporize;
directing rising vapors through the condenser to cool and condense the vapors into a liquid state, and directing the liquid through the filter to remove and capture impurities therefrom and produce pure distilled water;
directing the pure distilled water from the filter into the reservoir holding a predetermined volume of the pure distilled water for ready dispensing on demand;
automatically monitoring the level of the pure drinking water in the reservoir;
continuously re-activating the distillation cycle when the level drops below a given level to produce additional quantities of the pure distilled water and to automatically maintain the level at the given level and ceasing the distillation cycle when the level rises to the given level;
periodically carrying out the cleaning cycle to at least one of release and break down deposits and contaminants in the distillation chamber; and
periodically carrying out the filter rejuvenation cycle to release contaminants from the filter.
